(19) United States
(12) Patent Application Publication
(10) Pub. No.: US 2013/0341637 A1
(43) Pub. Date: Dec. 26, 2013

(54) CARBODIIMIDE PHOSPHORS

(71) Applicants: Tim Vosgroene, Ober-Ramstadt (DE); Holger WIinkler, Darmstadt (DE); Ralf Petry, Griesheim (DE); Andreas Benker, Lautertal (DE); Thomas Juestel, Witten (DE); Dominik Uhlech, Steinfurt (DE)

(72) Inventors: Tim Vosgroene, Ober-Ramstadt (DE); Holger WIinkler, Darmstadt (DE); Ralf Petry, Griesheim (DE); Andreas Benker, Lautertal (DE); Thomas Juestel, Witten (DE); Dominik Uhlech, Steinfurt (DE)

(73) Assignee: MERCK PATENT GMBH, Darmstadt (DE)

(21) Appl. No.: 14/004,032

(22) PCT Filed: Feb. 13, 2012
(86) PCT No.: PCT/EP2012/000629

§ 371 Date: Sep. 9, 2013

(30) Foreign Application Priority Data
Mar. 8, 2011 (DE) 10 2011 013 331.3

(51) Int. Cl. C09K 11/06

(52) U.S. Cl. CPC C09K 11/06
USPC 257/76; 534/15

(57) ABSTRACT

The invention relates to compounds of the general formula I

(Sr1-z-nCazEun)mMp(SiN2)m-x(CN2)xSi3wN4w+p (I)

where

M stands for Al, Ga, Y, Gd or Lu and

m stands for a value between 1 and 3 and

n stands for a value from the range 0.005 m n 0.2 m and

p stands for a value from 0 to 3 and

w stands for a value from 0 to 2 and

x stands for a value from the range 0 x m and

z stands for a value from the range 0 z 0.4,

and to a process for the preparation of these phosphors and to the use thereof as conversion phosphors or in lamps.

The invention relates to carbodiimide compounds, to a process for the preparation of these compounds and to the use thereof as conversion phosphors or in lamps.

Inorganic fluorescent powders which can be excited in the blue and/or UV region of the spectrum are achieving ever-greater importance as phosphors for phosphor-converted LEDs (pc-LEDs).

In the meantime, many phosphor material systems have been disclosed, for example alkaline-earth metal orthosilicates, thiogallates, garnets and nitrides, each of which are doped with Ce3+ or Eu2+. In particular, the last-mentioned nitride phosphors, for example M2Si5N8:Eu (also known as 2-5-8 nitrides) or MAISiN3:Eu (M =Ca and/or Sr), are currently the subject of intensive research since only they have emission wavelengths of greater than 600 nm and are therefore essential for the production of warm-white pc-LEDs having colour temperatures <4000 K.

A major disadvantage of the nitride phosphors is, however, their very complex preparation. The following processes are known for the preparation of phosphors of the composition M2Si5N8:Eu and MAlSiN3:Eu (where M=Ca, Sr and/or Ba):

Schnick et al., Journal of Physics and Chemistry of Solids (2000), 61(12), 2001-2006, describe 2-5-8 nitrides which are prepared in accordance with the following synthesis equation:

(2−x)M+xEu+5Si(NH)2→M2−xEuxSi5N8+N2+5H2

This preparation has the disadvantage of the use of highly moisture-sensitive starting materials, meaning that the process must be carried out under a protective gas, which makes large-scale industrial preparation more difficult.

Hintzen et al., Journal of Alloys and Compounds (2006), 417(1-2), 273-279, describe 2-5-8 nitrides which are prepared in accordance with the following synthesis equation:

(2−x)M+3N2+3xEuN+5Si3N4→3M2−xEuxSi5N8+0.5xN2

This preparation has the disadvantage of the use of highly moisture-sensitive starting materials, meaning that the process must be carried out under a protective gas, which makes large-scale industrial preparation more difficult.

Piao et al., Applied Physics Letters 2006, 88, 161908, describe 2-5-8 nitrides which are prepared in accordance with the following synthesis equation, inter alia from graphite and SrCO3 (which decomposes thermally to give SrO):

Eu2O3+SrO+C+N2+Si3N4→(Sr1−xEux)2Si5N8+CO

This method has the disadvantage that phase-pure phosphors are not obtained since they are contaminated with carbon.

Xie et al., Chemistry of materials, 2006, 18, 5578, describe 2-5-8 nitrides which are prepared in accordance with the following synthesis equation:

2Si3N4+2(2−x)MCO3 +x/2Eu20O3M2−xEuxSi5N8 +M2SiO4 +CO2

This method has the disadvantage that phosphors which are contaminated by o-silicates are obtained.

WO 2010/029184 describes a process for the preparation of 2-5-8 nitrides in which liquid ammonia is employed, which restricts the large-scale industrial preparation of such phosphors.

Uheda et al., Electrochem. Sol. Stat. Lett. 9 (4) H22-25 (2006), describe phosphors of the composition MAISiN3:Eu, which are prepared as follows:

1−xCa3N2+3xEuN+Si3N4+3AlN3Cal−xEuxAlSiN3+0.5x N2

It is disadvantageous here that the starting materials Ca3N2 and EuN used are moisture-sensitive, meaning that the process must be carried out under a protective gas, which makes large-scale industrial preparation more difficult.

Kijima et al., J. Alloy Comp. 475 (2009) 434-439, describe phosphors of the composition MAISiN3:Eu, which are prepared as follows:

1−x−yCa3N2+xSr3N2 +yEuN+Si3N4 +3AlN→3Ca1−x−ySrxEuyAlSiN3+0.5y N2

Moisture-sensitive starting materials, such as EuN or Ca3N2, are employed, and in addition the synthesis is carried out at a pressure of 19 MPa (hot isostatic pressing).

The object of the present invention is to develop nitride phosphors which have comparable phosphor properties to known 2-5-8 nitrides and have emission wavelengths of greater than 600 nm. A further object of the present invention consists in providing a process for the preparation of nitride phosphors of this type.

In addition, a further object of the invention consists in indicating various possible uses of these phosphors.

Surprisingly, it has now been found that nitride phosphors containing a carbodiimide group [CN2]2- achieve the above-mentioned object. A further advantage is that the use of stable starting materials means that the requirements of the preparation process are significantly lower compared with the above-mentioned preparation processes of 2-5-8 nitrides. The incorporation of the [CN2]2- group into the crystal lattice has become possible since the oxygen content of the starting materials employed is not sufficient for the carbodiimides employed to react quantitatively with the oxygen liberated. The content of [CN2]2- group in the crystal lattice can thus be controlled via the oxygen content of the starting materials.

The present invention therefore relates to a compound of the formula I

(Sr1−z−nCazEun)mMp(SiN2)m−x(CN2)xSi3wN4w+p (I)

where

M stands for Al, Ga, Y, Gd or Lu and

m stands for a value from the range 0<m≦3 and

n stands for a value from the range 0.005 m≦n≦0.2 m and

p stands for a value from the range 0≦p≦3 and

w stands for a value from the range 0≦w≦2 and

x stands for a value from the range 0≦x≦m and

z stands for a value from the range 0≦z≦0.4.

Al, Ga, Y, Gd and Lu here are in the trivalent oxidation state and Eu is in the divalent oxidation state.

The compounds of the formula I according to the invention are also referred to below for simplification as nitride phosphors.

m preferably stands for a value from the range 1≦m≦2.

w preferably stands for a value from the range 0≦w≦1.5 and particularly preferably from the range 0≦w≦1.

p preferably stands for a value from the range 0≦p≦2 and particularly preferably from the range 0≦p≦1.

z preferably stands for a value from the range 0≦z≦0.25.

In this range, the addition of Ca results in a long-wave shift in the emission wavelength without a significant decrease in the emission intensity occurring. Although a further increase in the Ca content (z>0.4) results in a further long-wave shift in the emission spectrum, the emission intensity decreases considerably, however, and phase mixtures are formed.

Particular preference is given in accordance with the invention to phosphors having emission maxima in the wavelength range from 600 to 640 nm, having the following compositions:

Sr1.96Eu0.04(SiN2)0.2(CN2)1.8Si3N4 λmax≈605 nm

Sr0.77Ca0.21 Eu0.02Al(SiN2)0.3(CN2)0.7N λmax≈618 nm

Sr1.56Ca0.4Eu0.04(SiN2)0.2(CN2)1.8Si3N4 λmax≈621 nm

Sr1.16Ca0.8Eu0.04(SiN2)0.2(CN2)1.8Si3N4 λmax≈631 nm

The invention furthermore relates to a process for the preparation of a compound of the formula I.

To this end, suitable starting materials selected from binary nitrides, carbodiimides and oxides, optionally in a mixture with other corresponding reactive forms, are mixed in a step a), and the mixture is thermally treated under at least partially reductive conditions in a step b).

The carbodiimides employed (in process step a) are preferably SrCN2 or CaCN2. These starting materials are preferably prepared from alkaline-earth metal oxalates, which are converted into the corresponding alkaline-earth metal carbodiimide, for example in an ammonia atmosphere. In accordance with the invention, at least one of the starting materials in step a) is preferably in the form of a carbodiimide.

The europium-containing starting materials employed are preferably europium oxide, europium carbonate or europium oxalate, with europium oxide being particularly preferred.

The binary nitrides employed are preferably calcium nitride, strontium nitride, aluminium nitride, gallium nitride, silicon nitride (Si3N4), yttrium nitride, lutetium nitride and/or gadolinium nitride, particularly preferably aluminium nitride and/or silicon nitride.

The above-mentioned thermal treatment in step b) is carried out at least partially under reducing conditions. The reaction is usually carried out at a temperature above 750° C., preferably at a temperature above 1000° C. and particularly preferably in the range 1200° C.- 1600° C. The at least partially reductive conditions here are established, for example, using carbon monoxide, forming gas or hydrogen (reducing) or at least by means of a vacuum or by means of an oxygen-deficiency atmosphere (partially reducing). A reducing atmosphere is preferably established in a stream of nitrogen, preferably in a stream of N2/H2 and particularly preferably in a stream of N2/H2 (90-70:10-30). In addition, the thermal treatment can be carried out in one or more steps, with a one-step treatment being preferred.

In a further embodiment, the phosphor of the formula I may additionally be mixed at least with a further phosphor material of the following:

oxides, garnets, silicates, aluminates, nitrides and oxynitrides, in each case individually or mixtures thereof with one or more activator ions, such as Ce, Eu, Mn, Cr. This is particularly advantageous if certain colour spaces are to be established.

The nitride phosphors of the formula I according to the invention are in particulate form and have a particle size which is usually between 50 nm and 10 μm, preferably between 5 μm and 20 μm.

In a preferred embodiment, the phosphors according to the invention in particle form have a continuous surface coating consisting of SiO2, TiO2, Al203, ZnO, ZrO2 and/or Y2O3 or mixed oxides thereof. This surface coating has the advantage that, through a suitable grading of the refractive indices of the coating materials, the refractive index can be matched to the environment. In this case, the scattering of light at the surface of the phosphor is reduced and a greater proportion of the light can penetrate into the phosphor and be absorbed and converted therein. In addition, the surface coating of matched refractive index enables more light to be coupled out of the phosphor since total internal reflection is reduced.

In addition, a continuous layer is advantageous if the phosphor has to be encapsulated. This may be necessary in order to counter sensitivity of the phosphor or parts thereof to diffusing water or other materials in the immediate environment. A further reason for encapsulation with a closed shell is thermal decoupling of the actual phosphor from the heat generated in the chip. This heat results in a reduction in the fluorescence light yield of the phosphor and may also influence the colour of the fluorescence light. Finally, a coating of this type enables the efficiency of the phosphor to be increased by preventing lattice vibrations arising in the phosphor from propagating to the environment.

In addition, the phosphors according to the invention may, in a further embodiment, also have a porous surface coating consisting of SiO2, TiO2, Al2O3, ZnO, ZrO2 and/or Y2O3 or mixed oxides thereof or of the phosphor composition. These porous coatings offer the possibility of further reducing the refractive index of a single layer. Porous coatings of this type can be produced by three conventional methods, as described in WO 03/027015, which is incorporated in its full scope into the context of the present application by way of reference: the etching of glass (for example soda-lime glasses (see U.S. Pat. No. 4,019,884)), the application of a porous layer, and the combination of a porous layer and an etching operation.

In a further, likewise preferred embodiment, the phosphor particles have a surface which carries functional groups which facilitate chemical bonding to the environment, preferably consisting of epoxy or silicone resin. These functional groups can be, for example, esters or other derivatives which are bonded via oxo groups and are able to form links to constituents of the binders based on epoxides and/or silicones. Surfaces of this type have the advantage that homogeneous incorporation of the phosphors into the binder is facilitated. Furthermore, the rheological properties of the phosphor/binder system and also the pot lives can thereby be adjusted to a certain extent. Processing of the mixtures is thus simplified.

The nitride phosphors according to the invention can particularly advantageously be employed in light-emitting diodes (LEDs), and especially in the pc-LEDs already mentioned above.

For use in LEDs, the phosphors according to the invention can also be converted into any desired outer shapes, such as spherical particles, flakes and structured materials and ceramics. These shapes are usually summarised under the term “shaped bodies”. The shaped body here is preferably a “phosphor body”.

The nitride phosphors of the formula I according to the invention are therefore particularly preferably employed in shaped bodies, or in phosphor bodies, comprising the nitride phosphors according to the invention.

The production of flake-form phosphor bodies as described above is carried out by conventional processes from the corresponding metal and/or rare-earth salts. The production process is described in detail in EP 763573 and DE 102006054331, which are incorporated in their full scope into the context of the present application by way of reference. These flake-form phosphor bodies can be produced by coating a natural or synthetically prepared, highly stable support or a substrate comprising, for example, mica, SiO2, Al2O3, ZrO2, glass or TiO2 flakes which has a very large aspect ratio, an atomically smooth surface and an adjustable thickness with a phosphor layer by a precipitation reaction in aqueous dispersion or suspension. Besides mica, ZrO2, SiO2, Al2O3, glass or TiO2 or mixtures thereof, the flakes may also consist of the phosphor material itself or be built up from one material. If the flake itself merely serves as support for the phosphor coating, the latter must consist of a material which is trans-parent to the primary radiation of the LED, or absorbs the primary radiation and transfers this energy to the phosphor layer. The flake-form phosphors are dispersed in a resin (for example silicone or epoxy resin), and this dispersion is applied to the LED chip.

The flake-form phosphors can be prepared on a large industrial scale in thicknesses of 50 nm to about 20 μm, preferably between 150 nm and 5 μm. The diameter here is 50 nm to 20 μm.

It generally has an aspect ratio (ratio of the diameter to the particle thickness) of 1:1 to 400:1 and in particular 3:1 to 100:1.

The flake dimensions (length x width) are dependent on the arrangement. Flakes are also suitable as centres of scattering within the conversion layer, in particular if they have particularly small dimensions.

The surface of the flake-form phosphor facing the LED chip can be provided with a coating which has an antireflection action with respect to the primary radiation emitted by the LED chip. This results in a reduction in back-scattering of the primary radiation, enabling the latter to be coupled better into the phosphor body according to the invention.

Suitable for this purpose are, for example, coatings of matched refractive index, which must have a following thickness d: d=[wavelength of the primary radiation of the LED chip/(4* refractive index of the phosphor ceramic)], see, for example, Gerthsen, Physik [Physics], Springer Verlag, 18th Edition, 1995. This coating may also consist of photonic crystals, which also includes structuring of the surface of the flake-form phosphor in order to achieve certain functionalities.

The production of the phosphors according to the invention in the form of ceramic bodies is carried out analogously to a solid-state diffusion process (YAG ceramic) described, for example, in DE 10349038, which is incorporated in its full scope into the context of the present application by way of reference. In this process, the phosphor is prepared by mixing the corresponding starting materials and dopants, subsequently subjected to isostatic pressing and applied directly to the surface of a chip in the form of a homogeneous, thin and non-porous flake. There is thus no location-dependent variation of the excitation and emission of the phosphor, which means that the LED provided therewith emits a homogeneous light cone of constant colour and has high light output. The ceramic phosphor bodies can be produced on a large industrial scale, for example, as flakes in thicknesses of a few 100 nm to about 500 μm. The flake dimensions (length×width) are dependent on the arrangement. In the case of direct application to the chip, the size of the flake should be selected in accordance with the chip dimensions (from about 100 μm*100 μm to several mm2) with a certain oversize of about 10% to 30% of the chip surface with a suitable chip arrangement (for example flip-chip arrangement) or correspondingly. If the phosphor flake is installed over a finished LED, all of the exiting light cone passes through the flake.

The side surfaces of the ceramic phosphor body can be coated with a light metal or noble metal, preferably aluminium or silver. The metal coating has the effect that light does not exit laterally from the phosphor body. Light exiting laterally can reduce the luminous flux to be coupled out of the LED. The metal coating of the ceramic phosphor body is carried out in a process step after the isostatic pressing to give rods or flakes, where the rods or flakes can optionally be cut to the requisite size before the metal coating. To this end, the side surfaces are wetted, for example, with a solution comprising silver nitrate and glucose and subsequently exposed to an ammonia atmosphere at elevated temperature. A silver coating, for example, forms on the side surfaces in the process.

Alternatively, currentless metallisation processes are also suitable, see, for example, Hollemann-Wiberg, Lehrbuch der Anorganischen Chemie [Textbook of Inorganic Chemistry], Walter de Gruyter Verlag or Ullmanns Enzyklopadie der chemischen Technologie [Ullmann's Encyclopaedia of Chemical Technology].

The ceramic phosphor body can, if necessary, be fixed to the baseboard of an LED chip using a water-glass solution.

In a preferred embodiment, the ceramic phosphor body has a structured (for example pyramidal) surface on the side opposite an LED chip. This enables as much light as possible to be coupled out of the phosphor body. The structured surface on the phosphor body is produced by carrying out the isostatic pressing using a compression mould having a structured pressure plate and thus embossing a structure into the surface. Structured surfaces are desired if the aim is to produce the thinnest possible phosphor bodies or flakes. The pressing conditions are known to the person skilled in the art (see J. Kriegsmann, Technische keramische Werkstoffe [Industrial Ceramic Materials], Chapter 4, Deutscher Wirtschaftsdienst, 1998). It is important that the pressing temperatures used are ⅔ to ⅚ of the melting point of the substance to be pressed.

The phosphors according to the invention can be excited over a broad range, extending from about 410 nm to 530 nm, preferably 430 nm to about 500 nm. These phosphors are thus not only suitable for excitation by UV- or blue-emitting light sources, such as LEDs or conventional discharge lamps (for example based on Hg), but also for light sources such as those which utilise the blue In3+line at 451 nm.

The present invention furthermore relates to a light source which comprises a semiconductor and at least one compound of the formula I. This light source is preferably white-emitting.

In a preferred embodiment of the light source according to the invention, the semiconductor is a luminescent indium aluminium gallium nitride, in particular of the formula

IniGajAlkN, where 0≦i, 0≦j, 0≦k, and i+j+k=1.

In a further preferred embodiment of the light source according to the invention, the light source is a luminescent arrangement based on ZnO, TCO (transparent conducting oxide), ZnSe or SiC or an arrangement based on an organic light-emitting layer (OLED).

In a further preferred embodiment of the light source according to the invention, the light source is a source which exhibits electroluminescence and/or photoluminescence. The light source may furthermore also be a plasma or discharge source.

Possible forms of light sources of this type are known to the person skilled in the art. These can be light-emitting LED chips of various structure.

The nitride phosphors according to the invention can either be dispersed in a resin (for example epoxy or silicone resin) or, in the case of suitable size ratios, arranged directly on the light source or alternatively arranged remote therefrom, depending on the application (the latter arrangement also includes “remote phosphor technology”). The advantages of remote phosphor technology are known to the person skilled in the art and are revealed, for example, by the following publication: Japanese Journ. of Appl. Phys. Vol. 44, No. 21 (2005), L649-L651.

The invention furthermore relates to a lighting unit, in particular for the back-lighting of display devices, which comprises at least one light source described above.

Such lighting units are employed principally in display devices, in particular also in liquid-crystal display devices (LC displays), having backlighting. The present invention therefore also relates to a display device of this type.

In a further embodiment of the present invention, it is preferred for the optical coupling of the lighting unit described above between the nitride phosphor and the semiconductor to be achieved by a light-conducting arrangement. This makes it possible for the semiconductor to be installed at a central location and to be optically coupled to the phosphor by means of light-conducting devices, such as, for example, optical fibres. In this way, it is possible to achieve lamps adapted to the lighting wishes which merely consist of one or various phosphors, which can be arranged to form a light screen, and an optical waveguide, which is coupled to the light source. In this way, it is possible to place a strong light source at a location which is favourable for electrical installation and to install lamps comprising phosphors which are coupled to the optical waveguides at any desired locations without further electrical cabling, but instead only by laying optical waveguides.

The present invention furthermore relates to the use of the compounds of the formula I according to the invention as phosphor, preferably conversion phosphor, particularly preferably for the partial or complete conversion of the blue or near-UV emission from a luminescent diode.

Preference is furthermore given to the use of the phosphors according to the invention for the conversion of blue or near-UV emission into visible white radiation.

The use of the nitride phosphors according to the invention in electroluminescent materials, such as, for example, electroluminescent films (also known as lighting films or light films), in which, for example, zinc sulfide or zinc sulfide doped with Mn2+, Cu+ or Ag+ is employed as emitter, which emit in the yellow-green region, is also advantageous. The areas of application of the electroluminescent film are, for example, advertising, display backlighting in liquid-crystal display screens (LC displays) and thin-film transistor (TFT) displays, self-illuminating vehicle license plates, floor graphics (in combination with a crush-resistant and slip-proof laminate), in display and/or control elements, for example in automobiles, trains, ships and aircraft, or also in domestic appliances, garden equipment, measuring instruments or sport and leisure equipment.

The following examples are intended to illustrate the present invention. However, they should in no way be regarded as limiting. All compounds or components which can be used in the compositions are either known and commercially available or can be synthesised by known methods. The temperatures indicated in the examples are always in ° C. It furthermore goes without saying that, both in the description and also in the examples, the added amounts of the components in the compositions always add up to a total of 100%. Percentage data given should always be regarded in the given context. However, they usually always relate to the weight of the part-amount or total amount indicated.

Even without further comments, it is assumed that a person skilled in the art will be able to utilise the above description in its broadest scope. The preferred embodiments should therefore merely be regarded as descriptive disclosure which is absolutely not limiting in any way. The complete disclosure content of all applications and publications mentioned above and below is incorporated into this application by way of reference.

### EXAMPLES

### Example 1: Preparation of Sr1.96Eu0.04(SiN2)0.2(CN2)1.8Si3N4

1.1. Preparation of strontium carbodiimide:

10 g of strontium oxalate are introduced into a boron nitride crucible and transferred into a tubular furnace, in which the material is converted virtually quantitatively into strontium carbodiimide for 8 hours at 800° C. under an ammonia atmosphere (120 l/h).

1.2. Preparation of Sr1.96Eu0.04(SiN2)0.2(CN2)1.8Si3N4

6.25 g of SrCN2 (49 mmol), 0.176 g of Eu203 (0.5 mmol) and 3.78 g of Si3N4 (27 mmol) are weighed out and mixed intensively in a hand mortar. This mixture is transferred into a boron nitride crucible and reductively calcined in a tubular furnace for 8 hours at 1400° C. under a nitrogen/hydrogen atmosphere. The resultant phosphor is mortared briefly and classified via a sieve having a mesh width of 20 μm.

The phosphor emits in the red wavelength region at λmax≈605 nm. The emission measurement is in each case carried out on an optically infinitely thick layer of the phosphor with excitation at 450 nm using an Edinburgh Instruments OC290 spectrometer at room temperature.

### Example 2: Preparation of Sr0.77Ca0.21 Eu0.02Al(SiN2)0.3(CN2)0.7N

2.1. Preparation of strontium carbodiimide as under 1.1.

2.2. Preparation of Sr0.77Ca0.21 Eu0.02A1(SiN2)0.3(CN2)0.7N

9.82 g of SrCN2 (77 mmol), 0.352 g of Eu2O3 (1 mmol), 1.04 g of Ca3N2 (7 mmol), 4.1 g of AIN (100 mmol) and 1.4 g of Si3N4 (10 mmol) are weighed out and mixed intensively in a hand mortar. This mixture is transferred into a boron nitride crucible and reductively calcined in a tubular furnace for 8 hours at 1400° C. under a nitrogen/hydrogen atmosphere. The resultant phosphor is mortared briefly and classified via a sieve having a mesh width of 20 μm.

The phosphor emits in the red wavelength region at λmax≈618 nm. The emission measurement is in each case carried out on an optically infinitely thick layer of the phosphor with excitation at 450 nm using an Edinburgh Instruments OC290 spectrometer at room temperature.

### Example 3: Preparation of the Reference Phosphor Sr1.96Eu0.04Si5N8

4.75 g of Sr3N2 (16.333 mmol), 0.166 g of EuN (1 mmol) and 5.666 g of Si3N4 (39.583 mmol) are weighed out in an argon-filled glovebox and mixed intensively in a hand mortar. This mixture is transferred into a boron nitride crucible and reductively calcined in a tubular furnace for 8 hours at 1600° C. under a nitrogen/hydrogen atmosphere. The resultant phosphor is mortared briefly and classified via a sieve having a mesh width of 20 μm.

### Example 4: Production of a Light-Emitting Diode

The phosphor from Example 1 is mixed with a 2-component silicone (OE 6550 from Dow Corning) in a tumble mixer in such a way that equal amounts of the phosphor mixture are dispersed in the two components of the silicone; the total concentration of the phosphor in the silicone is 8% by weight.

5 ml of each of the two phosphor-containing silicone components are mixed homogeneously with one another and transferred into a dispenser. With the aid of the dispenser, empty LED packages from OSA optoelectronics, Berlin, which contain a 100 μm2 GaN chip are filled. The LEDs are then placed in a heat chamber in order to solidify the silicone for 1 h at 150° C.

### DESCRIPTION OF THE FIGURES

FIG. 1: shows the emission spectrum of the phosphor

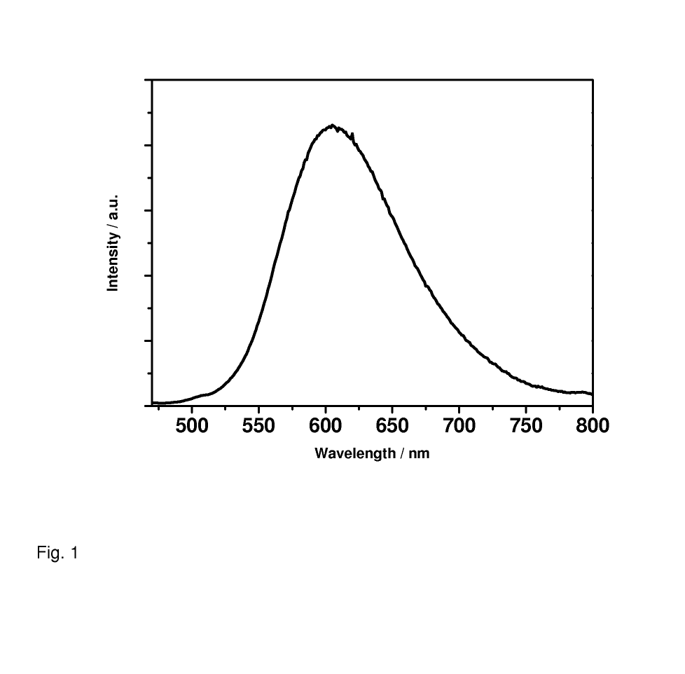

Sr1.96Eu0.04(SiN2)0.2(CN2)1.8Si3N4 according to the invention (peak at 605 nm)

The emission measurement is carried out on an optically infinitely thick layer of the phosphor with excitation at 450 nm using an Edinburgh Instruments OC290 spectrometer at room temperature.

FIG. 2: shows the emission spectrum of the phosphor

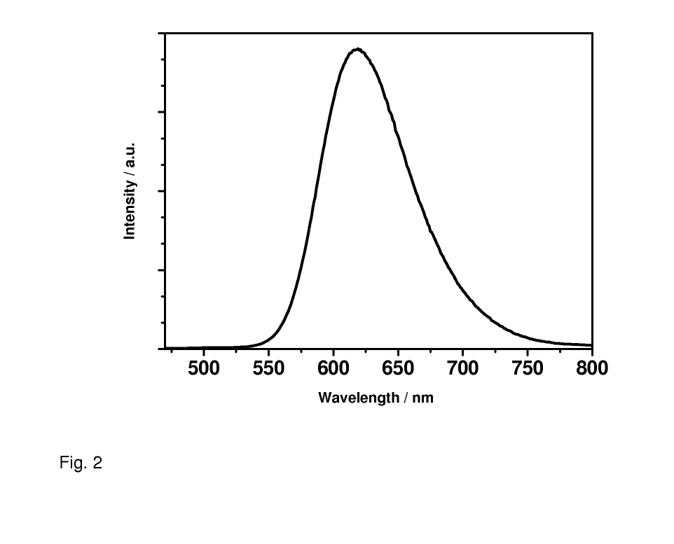

Sr0.77Ca0.21 Eu0.02Al(SiN2)0.3(CN2)0.7N according to the invention (peak at 618 nm)

The emission measurement is carried out on an optically infinitely thick layer of the phosphor with excitation at 450 nm using an Edinburgh Instruments OC290 spectrometer at room temperature.

FIG. 3: shows the comparative spectrum of the phosphor according to the invention from Example 1 (spectrum 1) with a 2-5-8 nitride (reference phosphor) of the composition Sr1.96Eu0.04Si5N8 (spectrum 2).

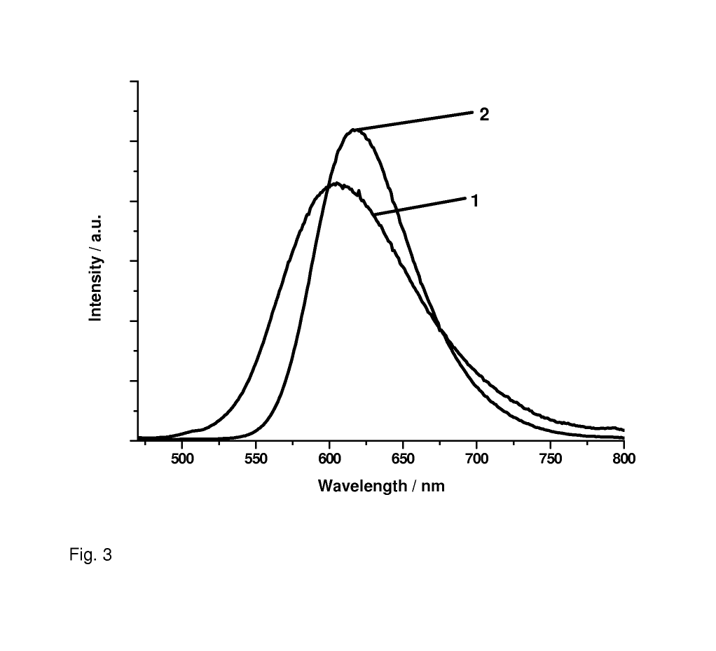

Although the peak intensity of the phosphor according to the invention is lower compared with the reference phosphor, the integral of the emission spectrum is, however, greater in the case of the phosphor according to the invention. The emission measurement is in each case carried out on an optically infinitely thick layer of the phosphor with excitation at 450 nm using an Edinburgh Instruments OC290 spectrometer at room temperature.

1. Compound of the formula I
(Sr1−z−nCazEun)mMp(SiN2)m−x(CN2)xSi3wN4w+p (I)
where
M stands for Al, Ga, Y, Gd or Lu and
m stands for a value from the range 0<m≦3 and
n stands for a value from the range 0.005 m≦n≦0.2 m and
p stands for a value from the range 0≦p≦3 and
w stands for a value from the range 0≦w≦2 and
x stands for a value from the range 0≦x≦m and
z stands for a value from the range 0≦z≦0.4.

2. Compound according to claim 1, characterized in that m stands for a value from the range 1≦m≦2.

3. Compound according to claim 1, characterized in that z stands for a value from the range 0≦z≦0.25.

4. Compound according to claim 1, characterized in that M stands for Al, Y or Lu, preferably Al.

5. Compound according to claim 1, characterized in that w stands for a value from the range 0≦w≦1.5, preferably 0≦w≦1.

6. Compound according to claim 1, characterized in that p stands for a value from the range 0≦p≦2, preferably from the range 0≦p≦1.

7. Process for the preparation of a compound of the formula I according to claim 1, characterized in that suitable starting materials selected from binary nitrides, carbodiimides and oxides, optionally in a mixture with other reactive forms, are mixed in a step a), and the mixture is thermally treated under at least partially reductive conditions in a step b).

8. Process according to claim 7, characterized in that the thermal treatment in step b) is carried out under reductive conditions.

9. Process according to claim 7, chacterized in that the reaction in step b) is carried out at a temperature >750° C., preferably at a temperature >1000° C. and particularly preferably in the range from 1200 to 1600° C.

10. Light source, characterized in that it comprises a semiconductor and at least one compound of the formula I according to claim 1.

11. Light source according to claim 10, characterized in that the semiconductor is a luminescent indium aluminium gallium nitride, in particular of the formula IniGajAlkN, where 0≦i, 0≦j, 0≦k, and I+j+k=1.

12. Lighting unit, in particular for the backlighting of display devices, characterized in that it comprises at least one light source according to claim 10.

13. Display device, in particular liquid-crystal display device (LC display), having backlighting, characterized in that it comprises at least one lighting unit according to claim 12.

14. A method which comprises generating a partial or complete conversion of the blue or near-UV emission from a luminescent diode comprising a conversion phosphor of a compound according to claim 1.
